(19) United States
(12) Patent Application Publication
(10) Pub. No.: US 2014/0176532 A1
(43) Pub. Date: Jun. 26, 2014

(54) METHOD FOR IMAGE CORRECTION AND AN ELECTRONIC DEVICE EMBODYING THE SAME

(71) Applicant: NVIDIA CORPORATION, Santa Clara, CA (US)

(72) Inventor: Yury Uralsky, Santa Clara, CA (US)

(73) Assignee: NVIDIA CORPORATION, Santa Clara, CA (US)

(21) Appl. No.: 13/727,060

(22) Filed: Dec. 26, 2012

(51) Int. Cl. G06T 15/00

(52) U.S. Cl. CPC G06T 15/00
USPC 345/419

(57) ABSTRACT

One aspect provides a method for image correction. The method, in one embodiment, includes obtaining two or more simultaneously captured images of an object, wherein the two or more simultaneously captured images are of different perspectives of the object taken from an electronic device. The method, in this embodiment, further includes inputting the two or more simultaneously captured images into an image processing algorithm and generating a disparity map, and applying an image interpolation algorithm to the disparity map to obtain an interpolated image from a virtual camera location.

### TECHNICAL FIELD

This application is directed, in general, to image correction and, more specifically, to image parallax correction and an electronic device embodying the same.

### BACKGROUND

Video conferencing is ubiquitous today, with televisions, personal computers, mobile phones and other types of consumer electronic devices having integrated high-quality digital cameras and network controllers. Unfortunately, while video conferencing is becoming widely available, it is not without its drawbacks. Accordingly, what is needed is an improved video conferencing method and associated electronic device.

### SUMMARY

One aspect provides a method for image correction. The method, in one embodiment, includes obtaining two or more simultaneously captured images of an object, wherein the two or more simultaneously captured images are of different perspectives of the object taken from an electronic device. The method, in this embodiment, further includes inputting the two or more simultaneously captured images into an image processing algorithm and generating a disparity map, and applying an image interpolation algorithm to the disparity map to obtain an interpolated image from a virtual camera location.

Another aspect provides an electronic device. The electronic device, in this aspect, includes a display having two or more image capture devices associated therewith, the two or more image capture devices separated by a parallax distance (D). The electronic device further includes, in this aspect, storage and processing circuitry associated with the display and two or more image capture devices. The storage and processing circuitry, in this aspect, is operable to: 1) obtain two or more simultaneously captured images of an object from the two or more image capture devices, wherein the two or more simultaneously captured images are of different perspectives of the object, 2) generate a disparity image of the two or more simultaneously captured images using an image processing algorithm, and 3) create an interpolated image from a virtual camera location proximate the display using an image interpolation algorithm.

### BRIEF DESCRIPTION

Reference is now made to the following descriptions taken in conjunction with the accompanying drawings, in which:

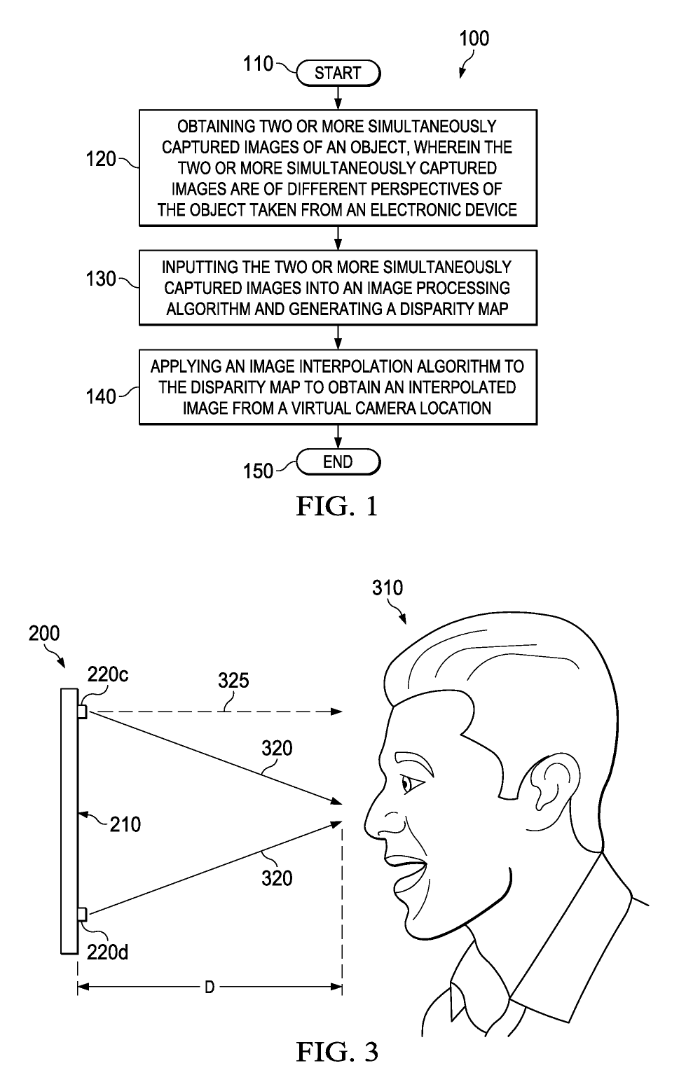

FIG. 1 a flow diagram of one embodiment of a method for image correction;

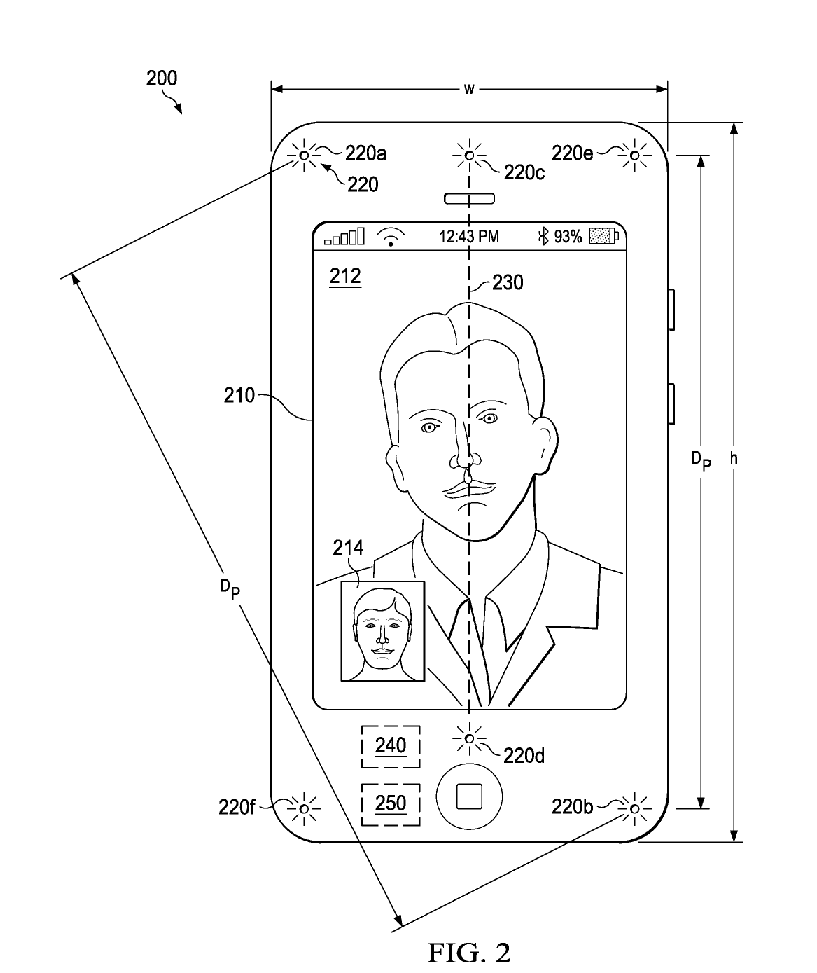

FIG. 2 illustrates aspects of a representative embodiment of an electronic device in accordance with embodiments of the disclosure;

FIG. 3 illustrates a side view of the electronic device of FIG. 2;

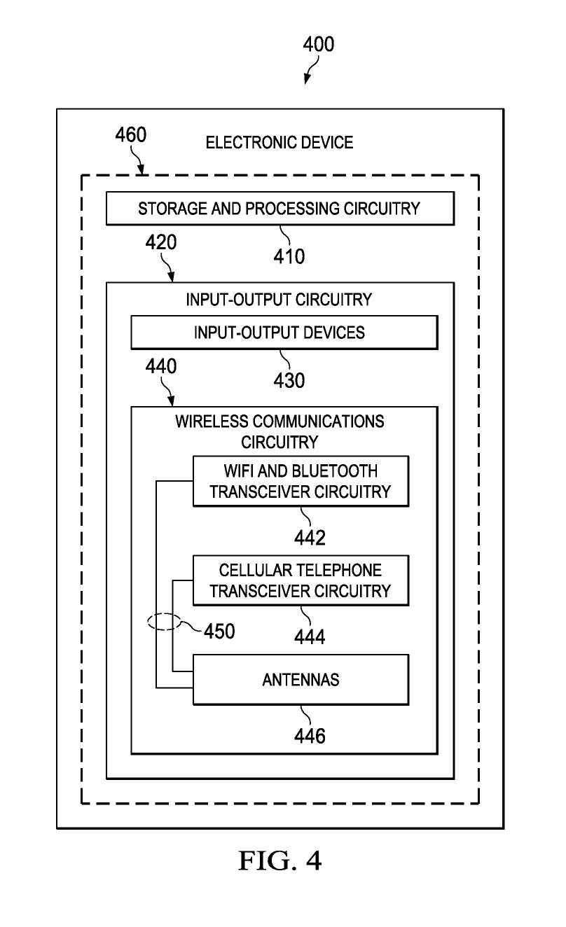

FIG. 4 illustrates a schematic diagram of electronic device manufactured in accordance with the disclosure; and

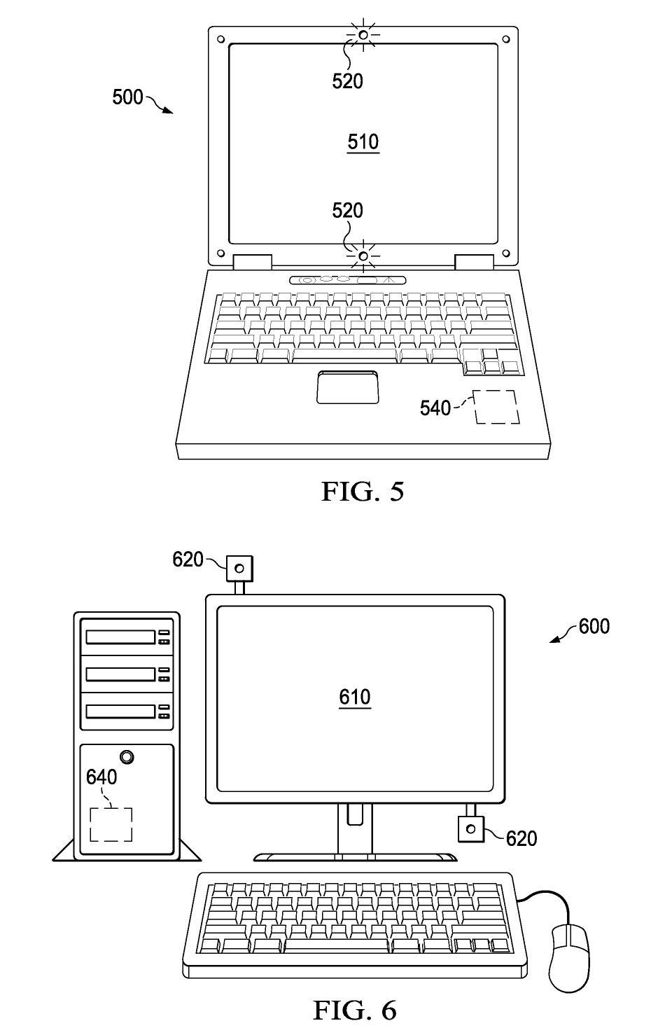

FIGS. 5-7 illustrate alternative aspects of a representative embodiment of an electronic device in accordance with embodiments of the disclosure;

### DETAILED DESCRIPTION

The present disclosure is based, at least in part, on the recognition that visual cues, such as subtle eye movements and facial expressions can be very important for social communication. The present disclosure has further recognized that one particularly important aspect of social communication is eye contact, which is thought to provide important nonverbal information and establish a kind of social connection between humans.

With these recognitions in mind, the present disclosure acknowledged that when videoconferencing, for example due to technological limitations on the spatial arrangement of the display panel and the video capture lens on existing devices, it is often very difficult to establish eye contact with the person on the other end of the communication channel. The present disclosure acknowledged that one reason for the lack of eye contact is that it is natural to look at the image of the person talking, rather than into the camera. The present disclosure further acknowledged that this effect is particularly accentuated on mobile devices, which are typically held very close to the user's face.

With the foregoing recognitions and acknowledgments in mind, the present disclosure establishes that the aforementioned problems can be reduced, or even eliminated, by integrating a second camera with the user's electronic device, at a (e.g., known) parallax distance (D_{P}) from the first (e.g., main) camera.

The present disclosure establishes that by having the input from both cameras, it is possible to run an image processing algorithm (e.g., optical flow algorithm) and calculate a disparity map for the two images. Then, at least in one embodiment, from this disparity map one could reconstruct an approximate depth image. The present disclosure establishes that an interpolation operation can be performed with the disparity map to position a “virtual” camera at a desired location (e.g., the center of the display panel, or better yet, at the eye position of the other person's image on the user's display). It is this interpolated image, which is from the perspective of the virtual camera, rather than the raw image from one of the cameras, which is then sent to the remote recipient's device for display.

The present disclosure has further acknowledged that these simple image processing operations can be easily performed at real-time speeds on contemporary graphics hardware. Moreover, the present disclosure has acknowledged that doing so will substantially enhance user's social experience when videoconferencing.

FIG. 1 is a flow diagram 100 of one embodiment of a method for image correction. The method for image correction begins in a start step 110 and continues on to step 120 wherein two or more simultaneously captured images of an object are obtained. The process of obtaining the two or more simultaneously captured images, in accordance with this disclosure, includes both a situation wherein the electronic device (e.g., user in one embodiment) obtaining the two or more simultaneously captured images is also taking the two or more simultaneously captured images, as well as a situation wherein the electronic device obtaining the two or more simultaneously captured images did not previously take the simultaneously captured images.

In accordance with one embodiment of the disclosure, the two or more simultaneously captured images are of different perspectives of the object taken from an electronic device. For example, the two or more simultaneously captured images might be obtained from two or more image capture devices separated by a parallax distance (D_{P}). The term “simultaneously captured”, as used throughout this disclosure, does not require absolute simultaneous, but just requires that the images be captured close enough to one another such that movement of the object the images relate to is relatively small and can be ignored by the image processing software.

In a step 130, two or more simultaneously captured images are input into an image processing algorithm. In one embodiment, the image processing algorithm is an optical flow algorithm. The image processing algorithm, in accordance with one embodiment, generates a disparity map. The term “disparity map”, as used throughout this disclosure is a data structure that encodes correspondence between pixels that represent the same region on the object's surface in the captured images. In one particular embodiment, a depth image is generated from the disparity map. The depth image encodes at each pixel a relative distance from the camera to the nearest point on the object's surface visible at that pixel. Those skilled in the art understand the myriad of different software packages (e.g., algorithms) that are capable of generating a disparity map (e.g., depth map in one example) from the two or more simultaneously captured images.

Thereafter, in a step 140, an image interpolation algorithm is applied to the disparity map. In one embodiment, the image interpolation algorithm provides an interpolated image from a virtual camera location. For example, the image interpolation algorithm provides the interpolated image, as that image might have appeared if taken from an intentionally placed virtual camera. Thus, even though no virtual camera physically exists, the interpolation algorithm applies information obtained from steps 120 and 130, to generate the interpolated image—as if the virtual camera did physically exist. Those skilled in the art understand the myriad of different software packages (e.g., algorithms) that are capable of obtaining the interpolated image from the two or more simultaneously captured images (e.g., using the disparity map).

Unique to the present disclosure, the virtual camera may be intentionally placed at a desired location, for example to facilitate social interaction with the person on the other end of the communications channel. As an example, in one embodiment, the virtual camera is positioned proximate a centerpoint of a display of the electronic device displaying the image of the person on the other end of the communications channel. In another embodiment, a face detection algorithm is subjected to the image of the person on the other end of the communications channel. Information obtained from the face detection algorithm may then be used to choose the virtual camera location. In one embodiment, information obtained from the face detection algorithm is used to position the virtual camera proximate an eye position of the image of the person on the other end of the communications channel.

In one embodiment, each of the steps 120, 130, 140 occur at substantially real-time speeds. The phrase “substantially real-time speeds”, as used herein, means the process of steps 120, 130, 140 can be timely used for video conferencing between two interconnected electronic devices. In those scenarios wherein a lag occurs that substantially impedes videoconferencing, steps 120, 130 and 140 are not occurring at substantially real-time speeds. The method for image correction would conclude in an end step 150.

Heretofore the present disclosure, the disclosed method was unrealistic to achieve. Specifically, the present disclosure benefits from a multitude of factors that have only recently (e.g., as a whole) been accessible. For example, only recently has image processing software, including the image processing algorithm (e.g., optical flow algorithm) and interpolation algorithm, been readily accessible to accomplish the desires stated above, for example in real-time. Additionally, only recently have electronic devices, particularly mobile electronic devices, had the capability to run the image processing (e.g., optical flow) and interpolation algorithms, for example in substantially real-time speeds. Moreover, only recently have image capture devices begun to have the resolution such that the communications issues discussed above, and addressed herein, have become an apparent problem. Likewise, image capture devices have only recently reduced in price to a level that it is economical, and thus feasible, to associate multiple image capture devices with a display, or in the case of mobile electronic devices, within the housing along with the display.

FIG. 2 illustrates aspects of a representative embodiment of an electronic device 200 in accordance with embodiments of the disclosure. The electronic device 200 illustrated in FIG. 2 is depicted as a mobile electronic device. Examples of mobile electronic devices include cellphones, tablet computers, handheld computers, ultraportable computers, laptop computers, a combination of such devices, or any other suitable portable electronic device including wireless communications circuitry. Notwithstanding, other electronic devices, including desktop computers, televisions, projectors, etc., as well as certain other electronic devices without wireless communications circuitry, are within the purview of this disclosure.

The electronic device 200 of FIG. 2 includes a display 210. The display 210, in one embodiment, is configured to display an image 212 of a user that the electronic device 200 is in communication with. The display 210, in one embodiment, is also configured to display an image 214 of the user using the electronic device 200. This multiple image configuration is consistent with common video conferencing applications.

The display 210, in accordance with the disclosure, includes two or more image capture devices 220 associated therewith. In the given example, image capture devices 220a-220f are not only associated with the electronic device 200, but form and integral part of the electronic device 200. This is particularly useful when the electronic device 200 is configured as a mobile electronic device. However, certain other embodiments (discussed briefly below) exist wherein the image capture devices 220 attach to, or are positioned proximate to, the electronic device 200.

The two or more image capture devices 220, in accordance with the disclosure, are separated by a parallax distance (D_{P}). The parallax distance (D_{P}), at least in the case of embedded image capture devices 220, may be a known value. Other embodiments may exist, for example wherein third party image capture devices 220 are being positioned proximate the display 210, wherein the parallax distance (D_{P}) is not known.

The two or more image capture devices 220 may be positioned in many different configurations. One embodiment exists, however, wherein the two or more image capture devices 220 are positioned proximate opposing edges of the display 210. For example, image capture devices 220a and 220e, as well as image capture devices 220b and 220e, are positioned proximate opposing edges of the display 210. Other embodiments exist wherein the image capture devices 220 are positioned proximate opposing sides of a centerpoint of the display 210. For example, one embodiment exists wherein the image capture devices are positioned such that a point on a line 230 connecting two or more image capture devices is proximate a centerpoint of the display. Such a configuration is achievable when the two or more image capture devices 220 are positioned across the centerpoint of the display 210 from one another, whether it is across the height (h), width (w), or diagonal of the electronic device 200. Examples of this configuration are image capture devices 220a and 220b, image capture devices 220c and 220d, and image capture devices 220e and 220f.

Turning briefly to FIG. 3, illustrated is a side view of the electronic device 200 of FIG. 2. In the illustrated view, a user 310 of the electronic device 200 is looking at the display 210 (e.g., the image 212). In this embodiment, optical axes 320 of the two or more image capture devices 220 intersect. The term “optical axis” or “optical axes”, as used herein, refers to an imaginary line, along which there is some degree of rotational symmetry, which defines the path along which light propagates through the system. For the purpose of understanding, arrow 325 represents the optical axis of a conventional image capture devices.

The optical axes 320 of the two or more image capture devices 220 are often coincident with the mechanical axis of the two or more image capture devices 220. Accordingly, at least in this scenario, if the mechanical axes of the two or more image capture devices 220 are perpendicular to a plane created by the display 210, they will not intersect. Alternatively, at least in this scenario, if the mechanical axes of the two or more image capture devices 220 are angled toward one another, as well as to a plane created by the display 210, they will intersect. In certain cases, such as when off-axes optical systems are used, the optical axis and mechanical axis are not coincident, and the foregoing scenario might not hold true.

In accordance with one embodiment of the disclosure, the optical axes 320 of the two or more image capture devices 220 intersect within a prescribed distance (D) of the display 210. The prescribed distance (D) may vary greatly based upon the electronic device 200 chosen. In one embodiment, for example wherein the electronic device 200 is a mobile electronic device, the optical axes 320 of the two or more image capture devices 220 intersect within a distance (D) of about 0.5 meters of the display 210. In another embodiment, the optical axes 320 of the two or more image capture devices 220 intersect within a distance (D) of about 0.3 meters of the display 210.

In one embodiment, the optical axes 320 of the two or more image capture devices 220 intersect at a distance (D) that approximates the distance a user would be viewing the display 210. Thus, if the display 210 were that of a television, the distance (D) might be greater than if the display 210 were that of a cellular telephone. The distance (D) might even be greater if the display 210 is a projection screen—as might be used with a projector.

In one embodiment, the two or more image capture devices 220 are automated such that their optical axes move from a first intersect point to a second intersect point. In this embodiment, the automated design would allow the intersect point to move, for example to a location proximate a facial feature of the object (e.g., user 310). A face detection algorithm, in one embodiment, might be used to move the intersect point proximate a facial feature of the object. This may occur in real-time.

Returning to FIG. 2, the electronic device 200 further includes storage and processing circuitry 240. The storage and processing circuitry 240, in one embodiment, is associated with the display 210 and two or more image capture devices 220. In accordance with the disclosure, the storage and processing circuitry 240, among other jobs, is operable to correct an image, for example as discussed above with regard to FIG. 1.

In one embodiment, the storage and processing circuitry 240 helps obtain two or more simultaneously captured images of an object (e.g., user 310 in one embodiment) from the two or more image capture devices 220. As an example, in this embodiment, the storage and processing circuitry 240 also helps generate a disparity image of the two or more simultaneously captured images using an image processing algorithm. As an example, in this embodiment, the storage and processing circuitry 240 also helps create an interpolated image from a virtual camera location proximate the display using an image interpolation algorithm.

The storage and processing circuitry 240, in one embodiment, is operable to generate a depth map (e.g., as a calculated from the disparity image). Additionally, the storage and processing circuitry 240, in one embodiment, is operable to create an interpolated image from a virtual camera location proximate a centerpoint of the display 210. The storage and processing circuitry 240, may also be operable to subject an image of a second object (e.g., image 212 of the opposing user) being displayed on the display 210 to a face detection algorithm. The storage and processing circuitry 240 may then use information obtained from the face detection algorithm to choose the virtual camera location. For example, the information obtained from the face detection algorithm may be used to position the virtual camera location proximate an eye position of the image 212 being displayed on the display 210. Interestingly, in one embodiment the storage and processing circuitry 240 can accomplish the foregoing at substantially real-time speeds.

The electronic device 200, in one embodiment, may further include wireless communications circuitry 250. The wireless communications circuitry 250 may include one or more antennas. In accordance with the disclosure, the wireless communications circuitry may be used to transmit the interpolated image created with the storage and processing circuitry 240 to another electronic device.

FIG. 4 shows a schematic diagram of electronic device 400 manufactured in accordance with the disclosure. Electronic device 400 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device. Electronic device 400 may additionally be a desktop computer, television, or projector system.

As shown in FIG. 4, electronic device 400 may include storage and processing circuitry 410. Storage and processing circuitry 410 may include one or more different types of storage such as hard disk drive storage, nonvolatile memory (e.g., flash memory or other electrically-programmable-read-only memory), volatile memory (e.g., static or dynamic random-access-memory), etc. Processing circuitry in storage and processing circuitry 410 may be used to control the operation of device 400. Processing circuitry may be based on a processor such as a microprocessor and other suitable integrated circuits. With one suitable arrangement, storage and processing circuitry 410 may be used to run software on device 400, such as image processing (e.g., optical flow) algorithm software and interpolation algorithm software, as might have been discussed above with regard to previous FIGs. The storage and processing circuitry 410 may, in another suitable arrangement, be used to run internet browsing applications, voice-over-internet-protocol (VoIP) telephone call applications, email applications, media playback applications, operating system functions, etc. Storage and processing circuitry 410 may be used in implementing suitable communications protocols.

Communications protocols that may be implemented using storage and processing circuitry 410 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3 G communications services (e.g., using wide band code division multiple access techniques), 2G cellular telephone communications protocols, etc. Storage and processing circuitry 410 may implement protocols to communicate using cellular telephone bands at 850 MHz, 900 MHz, 1800 MHz, and 1900 MHz (e.g., the main Global System for Mobile Communications or GSM cellular telephone bands) and may implement protocols for handling 3G and 4 G communications services.

Input-output device circuitry 420 may be used to allow data to be supplied to device 400 and to allow data to be provided from device 400 to external devices. Input-output devices 430 such as touch screens and other user input interfaces are examples of input-output circuitry 420. Input-output devices 430 may also include user input-output devices such as buttons, joysticks, click wheels, scrolling wheels, touch pads, key pads, keyboards, microphones, cameras, etc. A user can control the operation of device 400 by supplying commands through such user input devices. Display and audio devices may be included in devices 430 such as liquid-crystal display (LCD) screens, light-emitting diodes (LEDs), organic light-emitting diodes (OLEDs), and other components that present visual information and status data. Display and audio components in input-output devices 430 may also include audio equipment such as speakers and other devices for creating sound. If desired, input-output devices 430 may contain audio-video interface equipment such as jacks and other connectors for external headphones and monitors.

Wireless communications circuitry 440 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 440 may include radio-frequency transceiver circuits for handling multiple radio-frequency communications bands. For example, circuitry 440 may include transceiver circuitry 442 that handles 2.4 GHz and 5 GHz bands for WiFi® (IEEE 802.11) communications and the 2.4 GHz Bluetooth® communications band. Circuitry 440 may also include cellular telephone transceiver circuitry 444 for handling wireless communications in cellular telephone bands such as the GSM bands at 850 MHz, 900 MHz, 1800 MHz, and 1900 MHz, as well as the UMTS and LTE bands (as examples). Wireless communications circuitry 440 can include circuitry for other short-range and long-range wireless links if desired. For example, wireless communications circuitry 440 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 440 may include one or more antennas 446. Device 400 may be provided with any suitable number of antennas. There may be, for example, one antenna, two antennas, three antennas, or more than three antennas, in device 400. In accordance with that discussed above, the antennas may handle communications over multiple communications bands. If desired, a dual band antenna may be used to cover two bands (e.g., 2.4 GHz and 5 GHz). Different types of antennas may be used for different bands and combinations of bands. For example, it may be desirable to form an antenna for forming a local wireless link antenna, an antenna for handling cellular telephone communications bands, and a single band antenna for forming a global positioning system antenna (as examples).

Paths 450, such as transmission line paths, may be used to convey radio-frequency signals between transceivers 442 and 444, and antenna 446. Radio-frequency transceivers such as radio-frequency transceivers 442 and 444 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 450 may be used to interconnect the transceiver integrated circuits and other components on the printed circuit board with antenna structures in device 400. Paths 450 may include any suitable conductive pathways over which radio-frequency signals may be conveyed including transmission line path structures such as coaxial cables, microstrip transmission lines, etc.

The device 400 of FIG. 4 further includes a metal chassis 460. The metal chassis 460 may be used for mounting/supporting electronic components such as a battery, printed circuit boards containing integrated circuits and other electrical devices, etc. For example, in one embodiment, the metal chassis 460 positions and supports the storage and processing circuitry 410, and the input-output circuitry 420, including the input-output devices 430 and the wireless communications circuitry 440 (e.g., including the WIFI and Bluetooth transceiver circuitry 442, the cellular telephone circuitry 444, and the antennas 446).

The metal chassis 460 may be made of various different metals, such as aluminum. The metal chassis 460 may be machined or cast out of a single piece of material, such as aluminum. Other methods, however, may additionally be used to form the metal chassis 460.

FIG. 5 illustrates alternative aspects of a representative embodiment of an electronic device 500 in accordance with embodiments of the disclosure. The electronic device 500 of FIG. 5 is configured as a laptop computer. The electronic device 500 includes many of the features of the electronic device 200 of FIG. 2, including a display 510 having two or more image capture devices 520 associated therewith. The electronic device 500, similar to the electronic device 200, further includes storage and processing circuitry 540. The storage and processing circuitry 540, in accordance with this disclosure, is operable to accomplish the method discussed above with regard to FIG. 1.

FIG. 6 illustrates alternative aspects of a representative embodiment of an electronic device 600 in accordance with embodiments of the disclosure. The electronic device 600 of FIG. 6 is configured as a desktop computer. The electronic device 600 includes many of the features of the electronic device 200 of FIG. 2, including a display 610 having two or more image capture devices 620 associated therewith. The image capture devices 620, in this embodiment, are attached to (e.g., as opposed to as a part of) the display 610. The electronic device 600, similar to the electronic device 200, further includes storage and processing circuitry 640. The storage and processing circuitry 640, in accordance with this disclosure, is operable to accomplish the method discussed above with regard to FIG. 1.

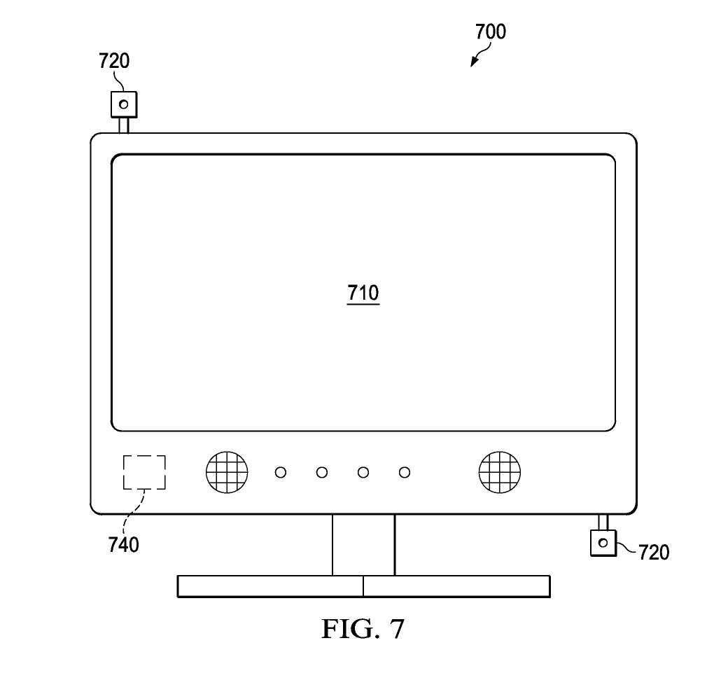

FIG. 7 illustrates alternative aspects of a representative embodiment of an electronic device 700 in accordance with embodiments of the disclosure. The electronic device 700 of FIG. 7 is configured as a television. The electronic device 700 includes many of the features of the electronic device 200 of FIG. 2, including a display 710 having two or more image capture devices 720 associated therewith. The image capture devices 720, in this embodiment, are attached to (e.g., as opposed to as a part of) the display 710. The electronic device 700, similar to the electronic device 200, further includes storage and processing circuitry 740. The storage and processing circuitry 740, in accordance with this disclosure, is operable to accomplish the method discussed above with regard to FIG. 1.

Those skilled in the art to which this application relates will appreciate that other and further additions, deletions, substitutions and modifications may be made to the described embodiments.

What is claimed is:

1. A method for image correction, comprising:
obtaining two or more simultaneously captured images of an object, wherein the two or more simultaneously captured images are of different perspectives of the object taken from an electronic device;
inputting the two or more simultaneously captured images into an image processing algorithm and generating a disparity map; and
applying an image interpolation algorithm to the disparity map to obtain an interpolated image from a virtual camera location.

2. The method of claim 1, wherein generating a disparity map includes generating a depth map.

3. The method of claim 1, wherein the virtual camera location is proximate a centerpoint of a display of the electronic device.

4. The method of claim 1, wherein the object is a first object, and further including subjecting an image of a second object being displayed on the display of the electronic device to a face detection algorithm.

5. The method of claim 4, wherein information obtained from the face detection algorithm is used to choose the virtual camera location.

6. The method of claim 5, wherein the virtual camera location is proximate an eye position of the second object.

7. The method of claim 1, wherein the inputting, generating and applying occur at substantially real-time speeds.

8. An electronic device, comprising:
a display having two or more image capture devices associated therewith, the two or more image capture devices separated by a parallax distance (D_{P}); and
storage and processing circuitry associated with the display and two or more image capture devices, the storage and processing circuitry operable to:
obtain two or more simultaneously captured images of an object from the two or more image capture devices, wherein the two or more simultaneously captured images are of different perspectives of the object;
generate a disparity image of the two or more simultaneously captured images using an image processing algorithm; and
create an interpolated image from a virtual camera location proximate the display using an image interpolation algorithm.

9. The electronic device of claim 8, wherein the storage and processing circuitry operable to generate a disparity image is storage and processing circuitry operable to generate a depth map.

10. The electronic device of claim 9, wherein the storage and processing circuitry operable to create an interpolated image from a virtual camera location proximate the display is storage and processing circuitry operable to create an interpolated image from a virtual camera location proximate a centerpoint of the display.

11. The electronic device of claim 8, wherein the object is a first object, and further wherein the storage and processing circuitry is operable to subject an image of a second object being displayed on the display to a face detection algorithm.

12. The electronic device of claim 11, wherein the storage and processing circuitry is operable to use information obtained from the face detection algorithm to choose the virtual camera location.

13. The electronic device of claim 12, wherein the virtual camera location is proximate an eye position of the second object being displayed on the display.

14. The electronic device of claim 8, wherein the storage and processing circuitry is operable to input, generate and create at substantially real-time speeds.

15. The electronic device of claim 8, further including wireless communications circuitry including an antenna operable to transmit the interpolated image to another electronic device.

16. The electronic device of claim 8, wherein the two or more image capture devices are positioned proximate opposing edges of the display.

17. The electronic device of claim 16, wherein a point on a line connecting the two or more image capture devices is proximate a centerpoint of the display.

18. The electronic device of claim 8, wherein the display and storage and processing circuitry form a portion of a device selected from the group consisting of:
a desktop computer;
a laptop computer;
a television.

19. The electronic device of claim 8, wherein optical axes of the two or more image capture devices intersect.

20. The electronic device of claim 19, wherein the optical axes of the two or more image capture devices intersect within a distance (D) of about 0.5 meters of the display.

21. The electronic device of claim 8, wherein the two or more image capture devices are automated such that their optical axes move from a first intersect point to a second intersect point proximate a facial feature of the object.
